(19) United States
(12) Patent Application Publication
(10) Pub. No.: US 2009/0216441 A1
(43) Pub. Date: Aug. 27, 2009

(54) METHOD AND SYSTEM FOR INDICATING THE LOCATION OF AN OBJECT

(75) Inventors: David Bainbridge, Hamilton (NZ); Matthew Jones, Wales (GB); Steven Robert Andrew Jones, Cambridge (NZ); Nigel Mendelsohn Warren, London (GB)

Correspondence Address: KNOBBE MARTENS OLSON & BEAR LLP, 2040 MAIN STREET, FOURTEENTH FLOOR, IRVINE, CA, 92614, US

(73) Assignee: The University of Waikato ,a University

(21) Appl. No.: 11/910,384

(22) PCT Filed: Mar. 30, 2006
(86) PCT No.: PCT/NZ2006/000063

§ 371 Date: Nov. 25, 2008

(30) Foreign Application Priority Data
Mar. 31, 2005 (NZ) 539184

(51) Int. Cl. G01C 21/00

(52) U.S. Cl. 701/211; 701/207; 701/213

(57) ABSTRACT

An object location indication apparatus which includes a position determination system adapted to determine the position of the apparatus a plurality of audio channels, each connected to an audio output device wherein each channel is associated with a direction, an audio signal supply element adapted to supply an audio component signal to each channel, said plurality of audio component signals in combination providing a substantially continuous composite audio signal, wherein the audio signal supply element modulates each audio component signal depending on the direction of travel required to reach the object from the position determined for the apparatus.

### TECHNICAL FIELD

This invention relates to a method and associated system for indicating the location of an object. Preferably the present invention maybe used as a navigational aid or prompt which is simple to use, and need not necessarily intrude on a users performance of another activity while being employed. Those skilled in the art should appreciate however that the present invention may also be used in other applications where simply the location of an object is to be indicated as opposed to navigation to an object, and reference to navigation in the main throughout this specification should in no way be seen as limiting.

### BACKGROUND ART

Numerous different forms of navigational aids have been developed to assist a user in navigating to a destination, preferably along a defined route. Navigational aids can optimise travel times and result in efficiencies in fuel consumption when vehicle transportation is involved.

One of the oldest forms of navigational aid is a map. A map provides a pictorial model of an area which can be employed by a user to find their current location and to plan a route to their destination.

However there are some problems associated with the use of maps as navigational aids. There is the possibility that a user may misinterpret their position on a map, and may incorrectly select the best route to their destination. Maps require abstract spatial thought processes which therefore can make them difficult to use by some persons lacking such skills. Furthermore maps cannot easily be read or used while continuously operating a vehicle, which can lead to safety issues and also misreading of map content.

Satellite navigation systems for vehicles have been developed to attempt to address the problems present in the use of traditional maps. Global positioning satellite receivers have previously been coupled with regional map databases and speech based output systems. These satellite navigation systems can give a verbal set of directions to a user when an input destination is supplied. The current position of the vehicle may be tracked using a GPS receiver with the vehicle driver being instructed to make appropriate navigational turns as required.

These types of systems work reasonably well as navigational aids. However, they require the installation of a number of relatively expensive electrical components within a vehicle and therefore can not necessarily be used as a navigational aid when a vehicle is not employed. Furthermore, there is still a requirement on the vehicle operator to pay close attention to the verbal instructions given by the navigational aid. A driver needs to concentrate on both operating the vehicle and also watching out for landmarks or indicators particular to the specific verbal directions given by the navigation system.

Some experimental work has also been completed recently to develop a spatially based audio navigational aid. The approach taken is described in “Personal and Ubiquitous Computing”, 6(4): 253-259; Holland, S., Morse, D. & Gedenryd, H. (2002). AudioGPS: Spatial Audio Navigation with a Minimal Attention Interface.

In the developments described, left and right audio channels were used to prompt a user to move left or right through the transmission of a navigation signal to either left or right channel. However, this development does not necessarily present a useable navigational aid, in that a user is left waiting for navigational tones, and has to concentrate on listening for such tones continuously.

An improved method and/or system for indicating the location of an object which addressed any or all of the above issues would be of advantage. In particular, an improved method or system which minimised the cognitive load placed on a user, and which also eliminated the need for a user to physically interact with or manipulate any form of apparatus or system would also be of advantage.

All references, including any patents or patent applications cited in this specification are hereby incorporated by reference. No admission is made that any reference constitutes prior art. The discussion of the references states what their authors assert, and the applicants reserve the right to challenge the accuracy and pertinency of the cited documents. It will be clearly understood that, although a number of prior art publications are referred to herein, this reference does not constitute an admission that any of these documents form part of the common general knowledge in the art, in New Zealand or in any other country.

It is acknowledged that the term ‘comprise’ may, under varying jurisdictions, be attributed with either an exclusive or an inclusive meaning. For the purpose of this specification, and unless otherwise noted, the term ‘comprise’ shall have an inclusive meaning—i.e. that it will be taken to mean an inclusion of not only the listed components it directly references, but also other non-specified components or elements. This rationale will also be used when the term ‘comprised’ or ‘comprising’ is used in relation to one or more steps in a method or process.

It is an object of the present invention to address the foregoing problems or at least to provide the public with a useful choice.

Further aspects and advantages of the present invention will become apparent from the ensuing description which is given by way of example only.

### DISCLOSURE OF INVENTION

According to one aspect of the present invention there is provided an object location indication apparatus which includes,

a position determination system adapted to determine the position of the apparatus, and

a plurality of audio channels, each connected to an audio output device, wherein each channel is associated with a direction, and

an audio signal supply element adapted to supply an audio component signal to each channel, said plurality of audio component signals in combination providing a substantially continuous composite audio signal,

wherein the audio signal supply element modulates each audio component signal depending on the direction of travel required to reach the object from the position determined for the apparatus.

According to yet another aspect of the present invention there is provided an object location indication apparatus substantially as described above which also includes an orientation determination system adapted to determine the orientation of the apparatus.

The present invention relates to an object location indication method and also preferably an apparatus or system adapted to implement such a method. Preferably the components or hardware employed to implement such a system may be relatively small or compact and also incorporate their own power supply giving the resulting system a portable configuration. The present invention may be adapted to provide an object location indication system which can be used independent of a vehicle, or any other large objects which may impede the freedom of movement of the user.

Reference in the main will also be made throughout this specification to the present invention being implemented as a navigation aid, where the object to have its location indicated is a final or intermediate destination of a user. The present invention may also be employed to guide a user along a predetermined route to their destination. Therefore, the object which is to have its location indicated can be a location, place, building or land mark for example.

However, those skilled in the art should appreciate that other types of objects may also have their locations indicated where these objects may be any form of resource, where the location of same is of interest to a user. For example, such objects may incorporate other people, vehicles, retail stock items or any other types of objects of potential value or of importance to a user. In addition such objects may also encompass non-physical elements, such as information which may, for example, be present in either a physical location or in a virtual computerised environment. Furthermore, those skilled in the art should also appreciate that the present invention need not necessarily be portable nor require its user to be mobile. For example, in some applications the present invention may be used to facilitate the tracking or monitoring of the current locations of various mobile objects if required.

Reference throughout this specification will also be made with the present invention having a physical implementation, through including a number of physical components allowing for navigation to a real world destination or resource. However those skilled in the art should also appreciate that the techniques and methodology employed in conjunction with the present invention may function equally well within a virtual computer simulation based environment, allowing the location of particular objects in such environments to be indicated and also allowing users to navigate within such virtual environments.

Preferably the present invention may include a position determination system. Such a position determination system may be adapted to locate or fix the current physical position of the system or apparatus employed by a user and therefore by default may determine the current location of a user.

In a further preferred embodiment a position determination system may be implemented through or by a global positioning satellite (GPS) receiver system. GPS receivers are well known in the art and can be obtained relatively inexpensively to provide a reasonable degree of accuracy in the determination of the receiver's current position.

However, in alternative embodiments GPS systems may not necessarily be employed as a position determination system. For example, cellular telephone sites may be used to triangulate the location of the apparatus provided through the determination of signal transmission strength from a number of cell sites. In this implementation, the apparatus may include a cellular telephone receiver which is configured to receive this signal.

Alternatively, customised beacons or markers may be distributed throughout an environment to function in a similar manner as road signs or road numbers. Such beacons may emit a characteristic signal to be detected by receiver circuitry included in the position determination system or in close proximity to the beacon, or alternatively may bear an identification marking which may be input into the apparatus by a user to positively identify their current location at the beacon involved.

Other alternatives which may be used to determine position include using a gyroscope or accelerometer. These instruments may be used to calculate distance and direction travelled from a known starting position. This information can then be used to determine the current position of an apparatus.

Reference throughout this specification will however be made to the present invention incorporating a GPS receiver as a position determination system. However, as discussed above those skilled in the art should appreciate that other types of technology may also be employed to fulfill this role and reference to the above only throughout this specification should in no way be considered limiting.

Furthermore, reference throughout this specification will also be made to the present invention incorporating a position determination system to be employed to calculate a position for a mobile user. However, in other embodiments such a position determination system may be used to calculate a position for the object to have its location indicated where such object may also be mobile. For example, a user's position may be determined (requiring a single position determination system) or alternatively both the user and the object to be located may be mobile, thereby requiring a position determination system for each.

Preferably, the present invention may incorporate a plurality of audio channels with each audio channel being connected to an audio output device.

Preferably, an audio channel may consist of or incorporate a signal transmission line connected to a speaker or other equivalent form of sound generation component. The present invention may employ a plurality of audio channels ranging from two channels (as is the case with a portable set of 2 channel headphones) through to five, seven or more speakers spatially displaced around the current position or location of a user.

The provision of a plurality of audio channels provides a spatially distinct array of audio sources. Each audio channel can therefore be associated with a particular direction through being capable of generating sound which is sensed by a user as emanating from the direction involved or associated with the channel.

Those skilled in the art should appreciate that the output of two or more audio channels may in combination also be associated with a particular direction. 3-dimensional sound fields may be generated by the output of a plurality of channels working together in combination, wherein a listener within the sound field may perceive sound emanating from a direction not immediately in front of any of the output speakers of the channels involved. This may be achieved by altering the delay between multiple channels. Sound may reach one ear before another, creating the impression that the sound is travelling from a particular direction. In such embodiments the audio channels provided may work together to in combination be associated with more discreet directions than the total number of individual audio channels provided. This means that it may not be necessary to have a speaker situated in the direction indicated as other ways of simulating sound emulating from one direction are available.

In a further preferred embodiment the present invention may include a pair of audio channels only associated with or connected to a pair of sound output speakers. In such embodiments these pair of channels and speakers may be configured or implemented as a portable headphone set capable of being worn by a user. The present invention may therefore use a left and a right hand channel with the direction associated with each channel being the same as that of the ear to which the channel delivers sound.

In alternative embodiments, multiple audio channels may be associated with or connected to a portable headphone set. Such a portable headphone set may include many output speakers, one for each audio channel provided, within each earpiece of the headphone set.

Reference throughout this specification will also be made to the present invention including a pair of audio channels only implemented through the provision of a set of headphones to be worn by a user. However, those skilled in the art should appreciate that more than two channels may be employed in conjunction with the present invention and reference to the above only throughout this specification should in no way be seen as limiting.

Preferably the present invention may also include an audio signal supply element. This supply element may be adapted to retrieve, receive or generate audio component signals to in turn be transmitted to and through each audio channel. These audio component signals may in combination form a continuous composite audio signal. In a preferred embodiment the composite audio signal provided may be composed of left and right channel audio component signals in the instance where the present invention incorporates two audio channels only.

In a preferred embodiment the substantially continuous composite audio signal delivered by the audio signal supply element may be in the form of or incorporate entertainment media such as music or speech which a user would normally listen to as a recreational pursuit. These composite audio signals are substantially continuous in that they provide an ongoing audio signal which the user listens to and monitors for the entertainment value present.

Using entertainment media within the format of the composite audio signal substantially improves the resulting usability of the system and integrates the methodology or functionality of the present invention into an activity which would normally be undertaken by a user for recreational purposes.

Preferably, the audio signal supply element may modulate the audio component signals delivered to each channel depending on the location of an object to be indicated in accordance with the present invention. Preferably the audio component signal delivered to each channel may be modulated depending on the direction of travel required from the user's current position to reach the object or destination involved, and also depending on the direction associated with each channel. In a further preferred embodiment all audio component signals may be modulated if the user needs to change their orientation or their direction of travel to reach an object which is to have its location indicated.

In a further preferred embodiment an audio component signal may be modulated through having its signal strength, volume or amplitude increased or decreased depending on the direction associated with a channel and the direction of travel required to reach a destination. In such instances the channel associated with the direction required to reach a destination may have the audio component signal supplied to it modulating with an increased or higher volume. Conversely, the channel associated with the opposite direction may have its volume modulated so as to effectively mute the channel. This will deliver to a user a sound source from only the channel associated with the direction in which they need to travel to reach the destination to which they are to navigate.

However, those skilled in the art should appreciate that the modulation of volume or signal amplitude need not be considered essential to the present invention. For example, in other instances the pitch, tone or frequency components of an audio component signal may be modulated to indicate to a user a direction in which an object lies. For example, in some instances an audio component signal may be modulated to a higher frequency to indicate the direction of travel to be taken by a user to reach a destination, whereas the opposite audio channel may be modulated to a lower frequency to indicate this direction should not be taken to reach the destination involved.

For example, in one alternative embodiment audio component signals may also be modulated depending on the distance between the current location of the invention and the object to have its location indicated. For example, in some instances the volume of one or more component audio signals may be modulated downwards as a user moves away from an object, or modulated upwards as a user moves towards an object.

In one preferred embodiment the present invention may also be adapted to apply a plurality of modulation schemes concurrently to the audio component signals involved depending on a number of variable operational or context related parameters. For example, various different types of modulation or filtering processes may be applied to audio component signals depending on the user's relationship to one or more objects of interest which potentially are to have their locations indicated.

In this way the locations of a plurality of objects of interest may be tracked or monitored depending on the current situation of a user. For example, in some instances the user's current location, their orientation, speed of travel, or proximity to other objects or resources may be used to select various or differing modulation schemes or filters to be applied concurrently in conjunction with the present invention. Reference to the use of a single modulation scheme only throughout this specification should in no way be seen as limiting.

In a preferred embodiment, the present invention may also include a user interface element which may be employed by a user to control the degree or extent of modulation applied to audio component signals. For example, in one preferred embodiment a user interface element may be implemented as a physical toggle switch which increases or decreases the extent of volume modulation (for example) depending on the preferences of the user.

Preferably, the present invention may also incorporate an orientation determination system. Such orientation determination systems may be used to detect in which direction a user is facing and hence which relative direction users should turn and travel in to reach an object. In a further preferred embodiment a compass with an electronic orientation detection system may be employed to implement such an orientation determination system. An electronic reading of the direction in which the compass is orientated (and hence the direction in which a user is facing) may be employed to in turn allow the accurate calculation of which channels should have their component signals modulated in accordance with the methodology of the present invention.

In an alternative embodiment an orientation determination system may be provided by a gyroscope which measures movement and direction from a known starting orientation, or an accelerometer which does the same.

Alternatively, an orientation determination system may be provided which uses a successive position determination extrapolation technique, calculating the signal strength from a radio signal site, or cellular signal site to determine a user's orientation. Other ways of determining the orientation of the apparatus which may also be used include radio frequency identification beacons which emit a signal on the radio frequency band. The above mentioned technologies may also be used in combination with each other to determine the position and orientation of a device.

In a preferred embodiment the present invention may also incorporate a microprocessor and some form of memory element adapted to store a model of the particular geographical region in which the present invention is to be used. This microprocessor and stored model or mapping facility may be employed to calculate a direction of travel to an object and also preferably, an optimised route to be taken by a user to reach such an object. The microprocessor employed may also be integrated as part of the audio signal supply element and may be used to apply the modulation required to each channel's supplied audio component signal.

In a further preferred embodiment the present invention may also incorporate a user input system adapted to allow a user to identify a particular object which is to have its location indicated. For example, in some instances an input system may be implemented to allow a user to enter a street address, map grid reference or GPS co-ordinates for a particular static physical location. The present invention may then be used to indicate to a user the direction they should travel in their current position to reach the location or destination they have identified. Those skilled in the art should appreciate that numerous different forms or implementations of such an input system may also be employed depending on the particular type of object to have its location indicated.

In a preferred embodiment the present invention may be integrated within a portable music playing device used for entertainment purposes to provide substantially continuous composite audio signals for a user to enjoy. The present invention may effectively re-use such existing equipment or hardware and also add additional functionality to portable music playing devices.

The present invention may provide many potential advantages over prior art.

The present invention may be implemented in some embodiments as a navigational aid which can be employed by users without necessarily placing an additional or significant cognitive load on the user. The present invention may provide audio cues or indicators to a user as to a direction of travel required to reach an object without necessarily interrupting the current pursuit or activity of a user. By employing a substantially continuous composite audio signal already being monitored by a user for entertainment purposes the methodology employed by the present invention need not necessarily intrude on a user's current activity.

The present invention may also provide a straight forward, simple and intuitive user interface system which need not require the physical manipulation of any apparatus or components by a user when employed.

Furthermore the present invention may also provide an enjoyable navigation experience to users. Users no longer need to be distracted or diverted from their current activity to complete a navigation process, and may in fact enjoy the novel and unique experience of listening to entertainment media while concurrently navigating to their destination, or having the locations of other objects or resources indicated to them.

### BRIEF DESCRIPTION OF DRAWINGS

Further aspects of the present invention will become apparent from the following description which is given by way of example only and with reference to the accompanying drawings in which:

FIGS. 1a-1f show block schematic diagrams of the orientation and progress of a user employing the present invention as a navigational aid in a preferred embodiment, and

FIG. 2 shows a block schematic diagram of the elements and components employed to provide a system for indicating the location of an object in the embodiment discussed with respect to FIGS. 1a through 1f, and

FIG. 3 shows a flow diagram of the processes executed by the elements shown in relation to FIG. 2.

### BEST MODES FOR CARRYING OUT THE INVENTION

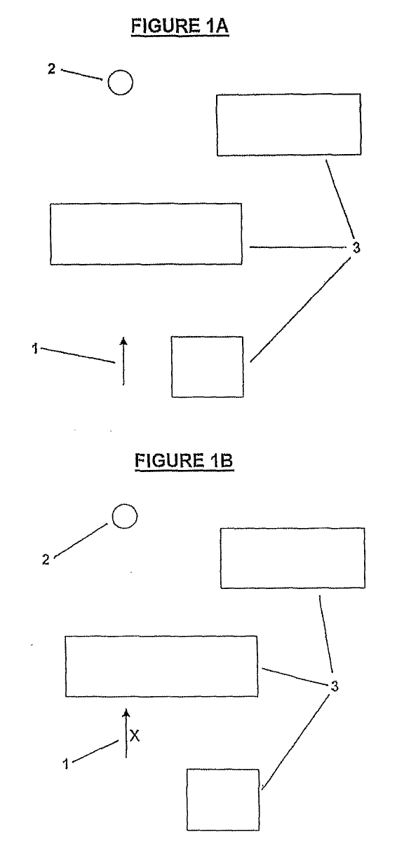

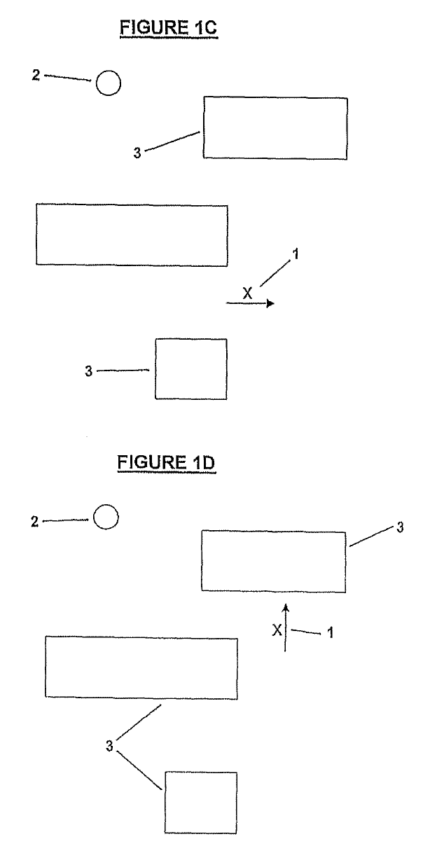

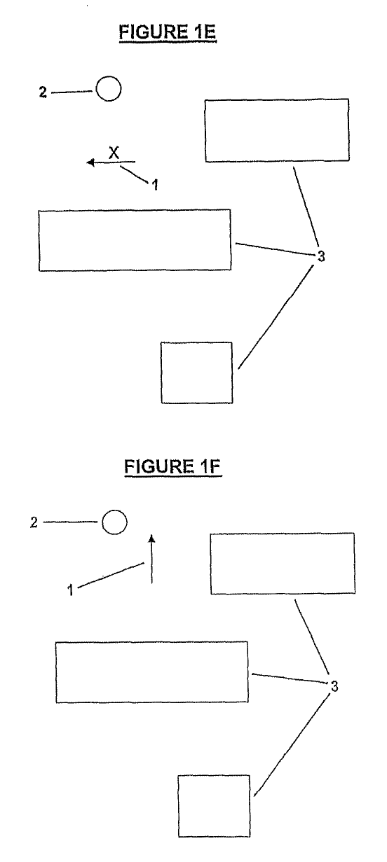

FIGS. 1a through 1f show block schematic diagrams of the orientation and progress of a user employing the present invention as a navigational aid in a preferred embodiment.

In the schematic view shown, a user of the present invention implemented as a navigational aid is shown as arrow (1). This arrow indicates the orientation or direction in which the user currently faces through various stages in the navigation process illustrated.

In the situation shown by these figures the user is attempting to navigate to a final destination point, shown by representatives as the circular object (2). The user must navigate around a series of obstacles (3) to reach the destination object (2).

FIG. 1a shows the starting position and orientation of the user (1). In a preferred embodiment the present invention is adapted to supply modulated left and right hand audio component signals to the ears of a user via a set of headphones. In the instance shown with respect with FIG. 1a neither of these component signals are modulated as the user is to initially travel to the position shown with respect to FIG. 1b.

Conversely once the user has reached the position shown with respect to FIG. 1b both the signals supplied to each of the left and right channels are modulated. The x reference shown with respect to FIG. 1b illustrates that the volume of the right hand channel is modulated so as to increase the volume of the right hand channel, whereas a left hand channel volume is modulated downwards to effectively mute the sound emanating from the left speaker of the left ear phone. This will represent to a user that they need to make a right hand turn and travel towards the position shown with respect to FIG. 1c.

A similar process is then followed with each subsequent navigational step, where at FIG. 1c the volume of the left hand channel is increased while the right channel is muted prompting a left turn of the user. The same approach is taken again to prompt a left hand turn once the user reaches the position shown with respect to FIG. 1d. The user then continues to travel onwards until they reach the position shown with respect to FIG. 1e where at this stage a right hand turn is signalled, prompting the user to travel to their final destination (2) as shown with respect to FIG. 1f.

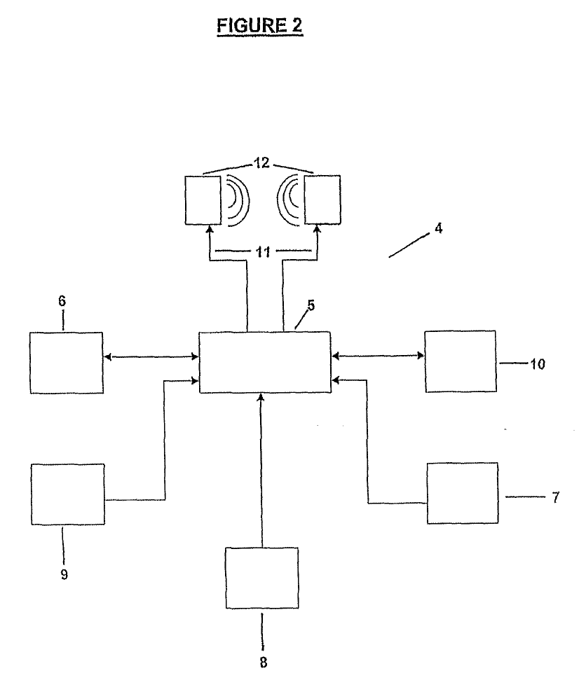

FIG. 2 shows a block schematic diagram of elements and components employed to provide a system for indicating the location of an object in the embodiment discussed with respect to FIGS. 1a through 1f.

FIG. 2 provides a schematic view of the series of components used to implement an apparatus (4) for indicating a location of an object. Preferably this apparatus may be adapted to provide a navigation aid and to function via the methodology discussed with respect to FIGS. 1a though 1f.

The apparatus (4) includes a microprocessor (5) linked to all other components of the apparatus.

The microprocessor (5) is linked to an input/output system (6) formed in this embodiment via a liquid crystal display and numeric keypad (not shown).

The microprocessor (5) is also linked to a mapping module (7) employed to model the geographical region in which the apparatus (4) is to be used. The mapping module (7) may supply content to be displayed via the LCD screen of the input/output module to indicate identification codes or grid references for specific destinations which a user of the apparatus (4) may wish to navigate to. The keypad of the input/output system may then be employed to enter such identifiers or grid references.

The apparatus (4) also includes a position determination system, shown in this embodiment as a GPS receiver (8). This GPS receiver may also be tied into the particular format or configuration of the geographical model stored in the mapping module (7) to allow the microprocessor to make a relative determination of the current position of the system (4) and also of a destination to which a user wishes to navigate (2).

The apparatus (4) also includes an orientation detection system (9) configured in this embodiment as a compass with an electronic output facility. This system may indicate to the microprocessor the current orientation or heading in which the system (4) is currently being held by a user.

The microprocessor (5) is also linked to a memory element (10) which stores a number of music files in electronic formats. A series of musical tracks may be stored in this memory element (10) allowing the microprocessor (5) to read each of the files involved to provide a substantially continuous composite audio signal composed of left and right channel audio component signals.

The apparatus (4) also includes a pair of audio channels (11) each linked in turn to an output speaker (12). A left hand side and right hand side channel and speaker combination are provided in this embodiment in the form of a set of headphones to be worn by a user.

As can be seen from FIG. 2 the microprocessor (5) implements a central component of the apparatus provided. The substantially continuous audio content supplied by the memory element (10) may have each of its channels modulated (either in volume or frequency) depending on the direction of travel required for a user of the apparatus (4) to transit to a location they have identified via the input/output system (6). The user's current position may be calculated using the GPS receiver (8) when compared with the required destination formed within the map module (7) and also the current orientation indicated for the apparatus via the orientation system (9). The microprocessor may then in turn calculate the direction of travel required, and modulate the component signals supplied to each of the left or right hand channels (11) as required to indicate to a user appropriate navigational turns they should make.

Set out below is an object orientated pseudocode listing which shows executable instructions adapted to be run by the microprocessor (5) discussed above.

begin process execution

execute musicPlayback subprocess
execute identifyDestinations subprocess
loop continuously

execute getGeospatialData subprocess
execute checkTargetAcquired subprocess
if map display required

execute updateMap subprocess

end if
execute modifyAudio subprocess

end loop

end process execution
subprocess checkTargetAcquired
begin subprocess execution

compute proximity of current location to target
destination
if distance offset is less than threshold

produce target acquired signal at speakers via
audio channels
if there are further targets

select next target destination from targets

end if

end if

end subprocess execution
subprocess modifyAudio
begin subprocess execution

compute distance offset of target destination from
current location
compute direction offset of target destination from
current orientation
modulate left of audio channels by a function of
distance offset and direction offset
modulate right of audio channels by a function of
distance offset and direction offset

end subprocess execution
subprocess getGeospatialData
begin subprocess execution

capture system current location from position
determination system
capture system current orientation from orientation
detection system

end subprocess execution
subprocess identifyDestinations
begin subprocess execution

retrieve a set of destinations (one or more) from memory
element
append a set of destinations (one or more) from user
compute ordered list of targets from destinations
select target destination from targets

end subprocess execution
subprocess musicPlayback
begin subprocess execution

determine music file for playback: specified by user
or stored on memory element
read music file from memory element
commence music playback via audio channels and speakers
providing a continuous audio signal

end subprocess execution
subprocess updateMap
begin subprocess execution

provide current location to map module
accept display content from map module
render display content to output system
render targets markers to output system

end subprocess execution

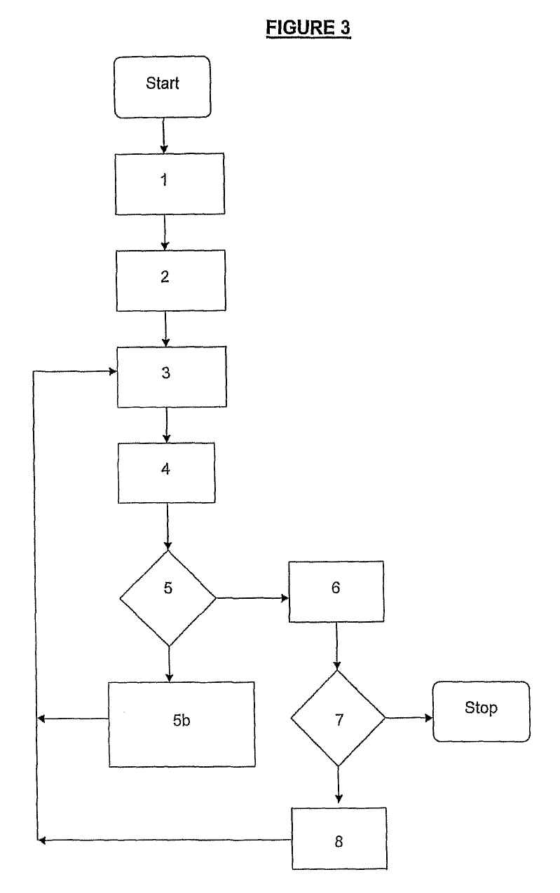

FIG. 3 shows a flow diagram of the steps used to employ the present invention as a navigational aid. The steps are as follows:

Step (1) Receive details of the target destination, or the object to be located.

Step (2) Start the music playback to the user.

Step (3) Receive information on the user's location from the position determination system (GPS) and on their orientation from the electronic compass as the user moves.

Step (4) As the user moves, update the visual display map to show them moving.

Step (5) Determine whether the user has reached their target destination. If no, proceed to step 5b, if yes proceed to step 6.

Step (5b) Modulate the left and right audio channels to indicate the distance and direction to target object of the user, then return to step 3.

Step (6) If the user has reached their destination, play ‘target object reached’ audio signal.

Step (7) Determine if there is another target.

Step (8) If further target, select this target and return to Step 3.

FIG. 3 shows one implementation of the navigational aid provided. This shows the processes completed by the microprocessor as seen in FIG. 2, using input from a user.

Aspects of the present invention have been described by way of example only and it should be appreciated that modifications and additions may be made thereto without departing from the scope thereof as defined in the appended claims.

1. An object location indication apparatus which includes,
a position determination system configured to determine the position of the apparatus relative to the object, and
a plurality of audio channels, each connected to an audio output device, wherein each channel is associated with a direction, and
an audio signal supply element configured to supply an audio component signal to each channel, said plurality of audio component signals in combination providing a substantially continuous composite audio signal, and
an orientation determination system configured to determine the orientation of the apparatus,
wherein the audio signal supply element modulates each audio component signal to each channel depending on the direction of travel required to reach the object from the position determined for the apparatus.

2. An object location indication apparatus as claimed in claim 1 wherein the orientation determination system is provided by an electronic compass.

3. (canceled)

4. An object location indication apparatus as claimed in claim 1 which is portable.

5. An object location indication apparatus as claimed in claim 1 wherein the composite audio signal delivered by the audio signal supply element is representative of entertainment media.

6. An object location indication apparatus as claimed in claim 1 which is employed to guide a user along a route to an object.

7. An object location indication apparatus as claimed in claim 1 wherein the object is a location.

8. An object location indication apparatus as claimed in claim 1 wherein the object is mobile.

9. An object location indication apparatus as claimed in claim 1 wherein the audio component signal is modulated by having its signal amplitude modified.

10. An object location indication apparatus as claimed in claim 1 wherein the channel associated with the direction required to reach a destination has the audio component signal supplied to it modulating so as to increase the volume of the signal in that channel.

11. An object location indication apparatus as claimed in claim 10 wherein the channel associated with the opposite direction has its volume modulated so as to decrease the volume of the signal in that channel.

12. An object location indication apparatus as claimed in claim 1 wherein the composite audio signal provided is composed of left and right channel audio component signals.

13. An object location indication apparatus as claimed in claim 1 wherein an audio channel is formed from a signal transmission line connected to a speaker.

14. An object location indication apparatus as claimed in claim 1 which includes a pair of audio channels connected to a pair of sound output speakers.

15. An object location indication apparatus as claimed in claim 14 wherein the pair of channels and speakers is formed as a portable headphone set capable of being worn by a user.

16. An object location indication apparatus as claimed in claim 1 wherein the position determination system includes a global positioning satellite (GPS) receiver system.

17. An object location indication apparatus as claimed in claim 1 wherein the position determination includes a cellular telephone receiver.

18. An object location indication apparatus as claimed in claim 1 wherein the position determination system is configured to receive signals from customised beacons.

19. (canceled)

20. An object location indication apparatus as claimed in claim 1 which includes a user interface element used to control the modulation applied to audio component signals.

21. An object location indication apparatus as claimed in claim 1 which includes a user input system which allows a user to identify a particular object which is to have its location indicated.

22. An object location indication apparatus as claimed in claim 1 including a mapping module containing a model of a geographical region containing the object and the apparatus.

23. An object location indication apparatus as claimed in claim 5 wherein the mapping module incorporates a microprocessor and a memory configured to include a model of the geographical region containing the object and the apparatus.
